(19) United States
(12) Patent Application Publication
(10) Pub. No.: US 2005/0203828 A1
(43) Pub. Date: Sep. 15, 2005

(54) Insurance claim information system

(75) Inventor: Daniel Lyakovetsky, Norwalk, CT (US)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: IntelliClaim, Inc.

(21) Appl. No.: 10/798,999

(22) Filed: Mar. 12, 2004

(51) Int. Cl. G06F 17/60

(52) U.S. Cl. 705/38; 705/1

(57) ABSTRACT

There is provided an insurance claim processing system. An agent converts a data point from a first format into a uniform format. The data point represents data from an insurance claim. A collector receives the data point in the uniform format and sends the data point to a data store. The data point is a member of a plurality of data points in the uniform format in the data store. An analyzer retrieves the plurality of data points from the data store and produces a metric from the plurality of data points.

### BACKGROUND OF THE INVENTION

1. Field of the Invention

The present invention relates to an insurance claim processing system. More particularly, the present invention relates to a system that monitors claims, compiles metrics, displays metrics in a customizable manner, and alerts a user to a situation that may require attention by the user.

2. Description of the Related Art

An insurance payor uses a claim processing system to manage receipt and payment of an insurance claim. Claim processing typically involves multiple workflows and steps. For example, claims submitted electronically go through a so-called “electronic data interchange (EDI) workflow”, while claims submitted on paper go through a so-called “Paper workflow”. EDI is a universally accepted manner of exchanging data, e.g., insurance claims, electronically.

Upon receipt of claim data by the claim processing system, the claim data is typically validated to identify and correct data errors, loaded into a database, then processed by a number of automated processing sub-systems, such as a claim editing sub-system, a claim adjudication sub-system, a claim pricing sub-system, etc. Each sub-system makes certain changes to the claim data. For example, the claim adjudication sub-system determines whether a claim for a service is covered by benefits of an insured person or entity, and the claim pricing system chooses an applicable payment rate based on a contract with a service provider.

As a further example, a healthcare provider submits a claim that reflects which services have been performed. Each claim has so-called service lines, one service line for each service. For each service line, the provider indicates a codified description of the service, e.g., office visit is “99213”, quantity of the services, and charged amount. The claim adjudication sub-system (a) determines the extent to which the services are covered by the benefits of the insurer (e.g., plastic surgery is not covered, for some other services the insured has deductibles, etc.), and (b) if the services are covered, then the reimbursement rate for the services is almost never what is requested by the provider, but the lesser of what is requested and a contractual rate.

In addition to the automated processing, the claim data is often placed in a “queue” for the subsequent manual processing. Thus, the claim processing system performs of a multitude of the interrelated automated and manual steps. The number of steps and a number of potential connections between the steps contribute to making the claim processing system very complex, dynamic, and often unpredictable. This in turn often results in delayed or inaccurate claim payments, which contributes to high costs and overall inefficiencies of the insurance industry.

### SUMMARY OF THE INVENTION

An embodiment of the present invention is an insurance claim processing system. An agent converts a data point from a first format into a uniform format. The data point represents data from an insurance claim. A collector receives the data point in the uniform format and sends the data point to a data store. The data point is a member of a plurality of data points in the uniform format in the data store. An analyzer retrieves the plurality of data points from the data store and produces a metric from the plurality of data points.

Another embodiment of the present invention is an insurance claim processing system that includes a first agent, a second agent, a collector and a compressor. A first data point represents data from an insurance claim, and a second data point also represents data from an insurance claim. The first data point is in a first format and the second data point is in a second format that is different from the first format. The first agent converts the first data point from the first format into a uniform format. The second agent converts the second data point from the second format into the uniform format. The collector receives the first and second data points in the uniform format and sends the first and second data points to a data store. The first and second data points are members of a plurality of data points in the uniform format in the data store. The compressor aggregates the plurality of data points from the data store, and produces a summary of the aggregated plurality of data points.

Yet another embodiment of the present invention is an insurance claim processing system that includes a first agent, a second agent, a collector and an analyzer. The first agent converts a first data point from a first format into a uniform format. The first data point represents data from an insurance claim. The second agent converts a second data point from a second format into the uniform format. The second data point represents data from an insurance claim. The second format is different from the first format. The collector receives the first and second data points in the uniform format and sends the first and second data points to a data store. The first and second data points are members of a plurality of data points in the uniform format in the data store. The analyzer retrieves the plurality of data points from the data store, produces a metric from the plurality of data points, and issues an alert if the metric satisfies an alertable condition.

### BRIEF DESCRIPTION OF THE DRAWINGS

FIG. 1 is a block diagram of system for processing insurance claim information.

### DESCRIPTION OF THE INVENTION

A metric is a named measurement describing performance of a system or entity. Examples of metrics are car mileage (miles per gallon), average annual rainfall (inches), time to answer phone calls (customer service), and gross domestic product.

An ability to execute an effective and efficient control over management of a claim processing system is a very important business tool for reducing cost and increasing quality of service in the insurance industry. A key instrument for enabling the management of such a complex and dynamic system is in accurate and timely monitoring of key business metrics. Such metrics include, for example, a number of claims that are currently in process by each processing step; a turn-around-time of each step; an impact of each step on a claim payment; and many others.

Each metric is typically represented not by a single number but by a distribution of numbers by certain dimensions, i.e., by “data cube”. That is, the metric is represented in a form of an n-dimensional matrix. Examples of the metrics represented by data cube include (a) a number of claims by line of business, by provider specialty, (b) claim adjustments by adjustment type by workflow queue, and (c) distribution of top ten service codes or top ten diagnoses.

A “data point” describes a single unit of work in a claim processing system. This single unit of work can be a claim, a claim line, a collection of claims grouped for processing (i.e., a batch of claims), or a collection of claims grouped by some common logic (i.e., an episode of care, or a “case”). An example of a data point is a computer record with information about a certain claim or a group of claims, where the record contains claim parameters for answering questions such as: “what is the status of the claim?”, “what is this claim for?”, “how long has the claim been in process?”, etc.

To successfully manage a claim processing enterprise, even of a moderate size, hundreds of metrics are routinely monitored. The number of claims received by the enterprise (e.g., tens of thousand per day), the number of metrics (e.g., hundreds), and the number of various dimensions of each metric (e.g., three to ten) involves a vast amount of data, and makes the effective and efficient monitoring of the metrics a task best handled by fully-automated, real-time processing of the data. Thus, even a moderate size enterprise can produce hundreds of thousands of individual data points that must be measured and reported via computation and assessment of hundreds of metrics.

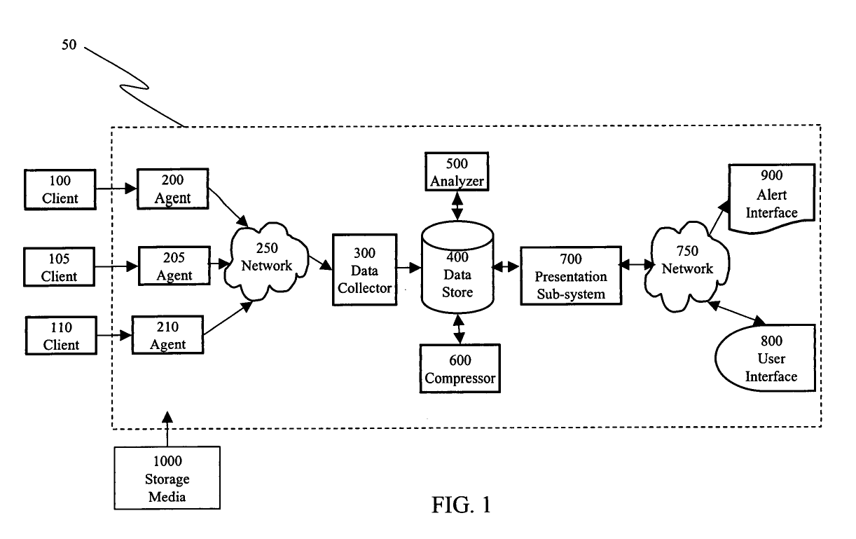

FIG. 1 is a block diagram of a system 50 for processing insurance claim information. System 50 provides effective and efficient real-time monitoring of claim processing by using design and technical innovations that yield maximum configurability and flexibility for precise and comprehensive reporting and alerting while providing for scalable throughput and responsiveness.

System 50 is described herein in the context of the health insurance industry. However, it may be employed for processing insurance claim information for any type of insurance.

System 50 includes a plurality of agents (e.g., agents 200, 205 and 210), a data collector 300, a data store 400, an analyzer 500, a compressor 600, a presentation sub-system 700, a user interface 800, and an alert interface 900. Agents 200, 205 and 210 communicate with data collector 300 via a network 250. Presentation sub-system 700 communicates with user interface 800 and alert interface 900 via a network 750. System 50 interfaces with a plurality of client systems (e.g., clients 100, 105 and 110) via agents 200, 205 and 210, with a user (not shown) via user interface 800, and with an alert subscriber (not shown) via alert interface 900.

The user of user interface 800 is a subject matter expert or operator employed or sub-contracted by client 100, 105 or 110 to manage and monitor system 50. The alert subscriber that interfaces via alert interface 900 is a subject matter expert or operator employed or sub-contracted by client 100, 105 or 110 to respond to alerts generated by system 50. Note that an individual person may be both of a user, i.e., having access to user interface 800, and an alert subscriber, i.e., having access to alert interface 900. Typically, an alert subscriber will also be a user of user interface 800.

An alert is a specific condition, requiring a certain level of attention or action from the alert subscriber. In practice, there will typically be a plurality of users, and so, a plurality of user interfaces 800. Similarly, there will typically be a plurality of alert subscribers, and so, a plurality of alert interfaces 900. There is not necessarily one alert interface 900 for each alert subscriber, as instead, system 50 may be configured with one alert interface 900 for each “class” of subscribers. Examples of classes of alert subscribers are technical operators receiving alerts via paging services, subject matter experts receiving alerts via e-mails, and senior managers viewing alerts.

Client 100 represents a claim processing system hosted by a healthcare insurance payor or by a third party on the payor's behalf. Client 100 is a source of data for system 50. Clients 105 and 110, similarly to client 100, represent claim processing systems hosted by other payors or third parties.

Agent 200 retrieves data from client 100. A single unit of data retrieved by agent 200 from client 100 is referred to herein as a data point. Agent 200 transforms the data point from a format provided by client 100 into a uniform format, that is, a uniform data format, and submits this data point in the uniform format to data collector 300 via network 250. Agent 200 may be installed either at a location of client 100, or remotely from client 100 and coupled to client 100 via a data link. Agents 205 and 210 are data collection agents for retrieving data points from clients 105 and 110, respectively, transforming data points into the uniform format, and sending the uniformly formatted data points to data collector 300. Thus, agents 205 and 210 are structurally and functionally similar to agent 200.

Agents 200, 205 and 210 connect to their respective clients 100, 105 and 110 to retrieve data points describing claims in a certain workflow step. For example, agent 200 may be responsible for retrieving data points from a “claim intake” step, while agent 205 is responsible for retrieving data points from a “payment” step.

As mentioned above, agents 200, 205 and 210 receive data points from their respective clients, and convert the data points into a uniform format. Thus, data points may be provided to system 50 in any industry standard or custom, i.e., client-specific format. Note also that each of clients 100, 105 and 110 may provide their respective data points to system 50 in a format that is different from that of the other two clients. That is, client 100 may provide data points in a first format, client 105 may provide data points in a second format, and client 110 may provide data points in a third format. Whereas agents 200, 205 and 210 convert data points to the uniform format, system 50 is data format agnostic and can consume data in any form or shape.

For example, assume that client 100 is an IBM® System/390® based (mainframe) claim processing system. IBM® and System/390® are trademarks of International Business Machines Corporation. The claim processing system of client 100 is employed by a national healthcare insurance payor, processing hundreds of thousands of healthcare (professional, inpatient, outpatient, and pharmacy) claims, each day, for a Medicare line of business. Also assume that agent 200 is configured as a set of a mainframe-based software programs (e.g., written in COBOL and Java™). Java™ is a trademark of Sun Microsystems Inc. Agent 200 (a) is invoked by a mainframe-based customer information control system (CICS) transactional system to pass client 100 data points (detailed information and processing status of each claim), (b) converts the data points into a uniform format (e.g., extensible markup language (XML)-encoded), (c) connects via network 250 to data collector 300, and (d) submits the data points in uniform format to data collector 300. Note that agent 200 converts the data points describing different types of claims (professional, inpatient, outpatient, and pharmacy) into the same uniform format.

For further example, assume that client 105 is a Microsoft® standard query language (SQL) server (Windows® operating system/Intel® platform) based claim processing system. Microsoft® and Windows® are trademarks of Microsoft Corporation, and Intel® is a trademark of Intel Corporation. The claim processing system of client 105 may be employed by the same national healthcare insurance payor as client 100, and may process tens of thousands of healthcare claims, each day, for a health maintenance organization (HMO) line of business. Additionally, assume that agent 205 is a set of Windows® based software programs (written in C# and C++). Agent 205 (a) retrieves client 105 data points, that is, detailed information and processing status of each claim stored in a Microsoft® SQL server database, (b) converts these data points into the uniform format (e.g., XML-encoded), (c) connects via network 250 to data collector 300, and (d) submits the data points in uniform format to data collector 300.

Network 250 is a communication media that includes physical and logical infrastructure, protocols, and applications, and that interconnects agents 200, 205, 210 and data collector 300 to facilitate a secure and reliable data transmission from agents 200, 205, 210 to data collector 300. An exemplary embodiment of network 250 is a local or wide area (wired or wireless) transmission control protocol/Internet protocol (TCP/IP)-based network that utilizes sockets-based, remote procedure call (RPC)-based, hypertext transfer protocol (HTTP) based or web services based application communication protocols for data transmission, and appropriate encryption and security techniques for data encryption and security. RPC is a standard computer protocol of executing programs located on a remote computer.

Data collector 300 collects data points, which are in a uniform format, from agents 200, 205, 210. Data collector 300 accepts a connection from agent 200, authenticates agent 200 by a login credential, e.g., a user name and a password, receives the data point from agent 200, validates the received data point. Thereafter, data collector 300 inserts the data points into data store 400. Data collector 300 may be implemented, for example, as a web service that accepts the incoming connections from its users via the Internet. In system 50, the users of data collector 300 are agents 200, 205 and 210.

Although data collector 300 receives the data points, in uniform format, these data points may describe claims data of different systems, i.e., client 100 and client 105. Receiving these data points in uniform format enables data collector 300 to apply common routines and processes for storing these data in data store 400.

A “metric definition” describes a manner in which the data point is used. One example of a metric definition is a distribution of a total claims payment amount by region, by product, by specialty, etc. Each metric definition has attributes such as (a) date interval, e.g., monthly, weekly, daily, etc., (b) dimensions, e.g., patient information, provider information, payment information, processing information, etc., and (c) calculable facts, e.g., total claim payment amount, total number of claims, etc. Other examples of metric definitions are (a) “operational metrics”, such as number, dollar amount, and turn-around-time of claims processed per claim system per type of claims per claims workflow per line of business per hour, (b) “data quality metrics”, such as distribution of most frequent procedure codes per provider specialty, and (c) “utilization metrics”, such as number of claims per subscriber per line of business.

Where a metric is a “named measurement”, e.g., daily rainfall in inches, a metric value is an observed/measured value, e.g., “3 inches”. Certain metric values, e.g., “above 10 inches”, represent an “alertable condition”, e.g., “flood warning”.

An “alertable condition” specifies which metric values constitute a situation that needs to be brought to the attention of an alert subscriber. An example of an alertable condition in system 50 is a situation where a number of claims received for a given day for a given region (e.g., “U.S. mid-west”) and a given workflow (e.g., “paper claims”) is more then a given number of standard deviations from a mean.

An “alert value” describes a situation that causes an alert by pointing to an actual metric value that caused the alert. For example, assume a metric of “a throughput of a claims system, measured hourly” (claims/hour). Also assume that when this value drops below a threshold of “1000 claims/hour”, system 50 needs to alert a claims operations manager of this condition. If a most recent value of this metric came to “750 claims/hour”, then there is an “alertable condition”, i.e., less than 1000 claims/hour, and therefore system 50 issues the alert, e.g., pages the claims operations manager. In this example, the actual measured value of 750 claims/hour is the “alert value”, i.e., the actual value that satisfied the alertable condition and therefore caused the alert.

A “user profile” is a description of display preferences and access permissions of users who access system 50 via user interface 800.

An “alert subscription” is a description of which alertable conditions are assigned to which of the alert subscribers.

Data store 400 is a sub-system that provides for storage and secure role-based access to: (a) data points; (b) metric definitions; (c) alertable conditions; (d) alert values; (e) user profiles; and (f) alert subscriptions. For example, data store 400 can be a relational database management system (RDMS) such as an Oracle® or Microsoft® SQL Server®. When implemented as an RDMS, data store 400 stores data in a form of interlinked tables, and provides standard and secure access to the data, e.g., via use of SQL. When data store 300 receives a data point from data collector 300, data store 400 stamps the data point with a data point creation date, e.g., today's date, and a data point expiration date, e.g., 30 days after the data point creation date.

Analyzer 500 is a sub-system that monitors metric data from data store 400 and determines whether there is an occurrence of an alertable condition. More specifically, analyzer 500 retrieves and analyzes the metric data from data store 400. The analysis of metric data may include, for example, (a) a comparison of metric data with a preset threshold value, also known as a threshold-based condition, such as an average turn-around-time of claims processed per claim system is below ten seconds, (b) a comparison of metric data with a dynamically computed property of a past metric, also known as an experience-based condition, e.g., a moving average or a standard deviation from a mean, such as a number of rejected claims per provider specialty is more than one standard deviations away from an historical mean value, and (c) a comparison of metric data that involves complex reasoning, also known as a rule-based condition, such as a number of painkiller prescriptions written by a certain provider does not match a number of patients seen by the provider. Analyzer 500 can produce, from data points obtained from data store 400, a first metric in a form of a data cube having a first set of dimensions, and a second metric in a form of a data cube having a second set of dimensions.

Note that analyzer 500 may analyze data points representing different claim types, e.g., outpatient and pharmacy, collected from the claim systems of clients 100, 105 and 110 in any industry standard data format or client-specific data format. The conversion of the industry standard data format or client-specific data format into a uniform format by agents 200, 205 and 210, enables analyzer 500 to use the data in the uniform format to analyze and compare data collected from different sources and different clients. For example, analyzer 500 can analyze and compare claims data received from a mainframe-based claim system with claims data received from a SQL server based claim system, even though these systems store data in the different formats. Thus, system 50 allows for a simultaneous use and comparison of the data of multiple types, received from multiple and different sources, e.g., comparing a number of painkiller prescriptions with a number of outpatient visits. Therefore, system 50 provides intelligent monitoring of scores of metrics without requiring a human to read each metric in the context of metric's history.

If analyzer 500 recognizes an occurrence of an alertable condition, analyzer 500 creates an alert value, i.e., a record in data store 400, that holds the definition and description of the specific occurrence of the alertable condition.

Presentation sub-system 700 facilitates interaction between (i) user interface 800 and the other components of system 50, and (ii) alert interface 900 and the other components of system 50. More specifically, presentation sub-system 700 (a) retrieves the data point from data store 400 and transforms the data point into a metric form as described by the metric definition, (b) sends the data in metric form to user interface 800 and alert interface 900 via network 750, (c) receives an input from user interface 800 for modifying a metric definition, an alertable condition, an alert subscription, or a user profile, and (d) receives an input from user interface 800 to acknowledge the receipt of the alert by the alert subscriber. In addition, presentation sub-system 700 authenticates the one or more users of user interface 800 in order to permit the users to access system 50 in accordance with the access permissions stored in each user profile.

Network 750 is a communication media that includes physical and logical infrastructure, protocols, and applications, and that interconnects presentation sub-system 700 with user interface 800 and alert interface 900 for facilitating a secure and reliable data transmission between presentation sub-system 700, user interface 800 and alert interface 900. Network 750 is a local or wide area (wired or wireless) TCP/IP-based network, which utilizes sockets-based, RPC-based, HTTP-based or web services-based application communication protocols for data transmission, and appropriate encryption and security techniques for data encryption and security.

User interface 800 is a sub-system for (a) rendering the metric received from presentation sub-system 700 on a user display, e.g., a computer screen; (b) receiving an input from the users, dynamically adjusting the display of the metric on the user display; (c) sending the user's input to presentation sub-system 700.

Alert interface 900 is a sub-system for sending alert values from presentation sub-system 700 to appropriate alert subscribers via a suitable communication technology. Examples of such a communication technology include e-mails, pages, short text messages, etc.

For example, presentation sub-system 700, based on the metric definition of “operational metrics” (number, dollar amount, and turn-around-time of claims processed per claim system per type of claims per claims workflow per line of business per hour) retrieves metrics in a form of a 5-dimensional (claim system, type of claim, claim workflow, line of business, hour) matrix, i.e., a data cube. Presentation sub-system 700 converts this data cube into metric form, e.g., XML, saves this data cube in metric form into a computer file, and makes this computer file available for subsequent rendering and display, via network 750, by user interface 800, e.g., an Internet web browser.

Acceptance of the industry standard format data or client-specific format data from clients 100, 105 and 110, and conversion to the uniform format by agents 200, 205 and 210 facilitates transmission of metrics (data cubes) from presentation sub-system 700 to user interface 800 and alert interface 900. The acceptance of the industry standard format data or client-specific format data also enables expansion of system 50 by integration with various third party software and devices.

If the metric is recognized by analyzer 500 as having an alertable condition, presentation sub-system 700 adds the alert value information to the data cube so that it is available for subsequent enhanced display by user interface 800 (e.g., the alert values are displayed in red color and bold typeface, or with any suitable color or feature). Also, if the metric is recognized by analyzer 500 as having an alertable condition, presentation sub-system 700 sends the alert (e.g., a page) to alert subscribers (e.g., operations staff) via alert interface 900 (e.g., a paging service).

Upon the receipt of the alert, the alert subscriber must acknowledge or cancel the alert by, for example, replying to the alert, or by using a special screen on user interface 800. Analyzer 500 forces an escalation of the alert if the alert is not acknowledged or resolved by an alert subscriber in a timely fashion. If the alert is not acknowledged during a certain time interval, e.g., one hour, the alert is repeated and escalated, e.g., sent to an operations staff supervisor.

The alert subscriber is expected to use his or her expertise and/or policies and guidelines to confirm whether the alert needs to be further acted upon (to remedy the underlying alertable condition), or whether the alert can be safely ignored. For example, if the alert indicates that a throughput of system 50 is below a minimally accepted threshold, the alert subscriber (e.g., a claims operations manager) may check with a computer operations department for an unexpected slowness of some part of system 50 (e.g., drop in network speed).

Compressor 600 is a sub-system for compressing the data points by a technique referred to herein as compression by aggregation. Compression by aggregation reduces the size of a data set by replacing the data set with one or many summaries of its content. This method of compression typically leads to a loss of detailed information, and as such, it is suitable for a situation where the detailed information is no longer needed. Compression by aggregation enables an active use of historical data without the necessity to store a large amount of collected data.

An “aggregation condition” describes a situation where a data point no longer needs to be stored in data store 400 in the form in which the data point was received from data collector 300. For example, the data points collected on hourly basis, while important for up-to-the-last-minute monitoring of the critical metrics (e.g., claims system throughput rate), lose their relevance after some time (e.g., on the next day). However, even though their real-time relevance is diminished, as a group, these hourly data points still possess some valuable information, e.g., an average hourly throughput rate for the given day: Accordingly, the hourly data points can be “compressed”, or “collapsed”, or aggregated into average daily data points, then, after some time, e.g., a week, the daily data points can be aggregated into weekly data points, weekly data points aggregated into monthly, and so forth.

Compression by aggregation, as employed by compressor 600, includes (a) producing a summary of the data points that meet the aggregation condition, (b) storing the summarized data points information in data store 400, and (c) deleting the original data point from data store 400 and moving it to a permanent long-term storage device (not shown). Examples of this compression approach include (a) producing a weekly summary of daily data points from a seven-day period, thus reducing a quantity of data seven-fold, (b) producing a monthly summary from several weekly summaries, (c) producing a quarterly summary from several monthly summaries, and (d) producing an annual summary from several quarterly summaries.

Compressor 600 retrieves, from data store 400, “expired” data points, based on a comparison of the data point expiration date and todays date. Compressor 600 creates summaries, i.e., summarized data points, of the expired data points. These summaries are represented as data points. Compressor 600 inserts the summarized data points in uniform format into data store 400. Compressor 600 stamps the creation date (e.g., today's date) and the expiration date (e.g., 30 days from today) on these summarized data points. After these summarized data points are created, compressor 600 removes, from data store 400, the expired data points, i.e., the original data points, and stores the original data points to a long-term offline storage device, e.g., a magnetic tape device. Thus, a multitude of expired data points is replaced with a much smaller number of summary data points, providing for an overall reduction of size (compression) of data in data store 400. Keeping the summarized data points in the same uniform format as the original data points (a) allows other sub-system, e.g., analyzer 500, to treat the summarized data points in a same way as the original data points, and (b) allows for further compression of summarized data points using the same compression algorithm and the same compressor sub-system, namely, compressor 600.

The operation of compressor 600 is now further described by way of example. Agent 200 collects, from client 100, detailed claim processing information, e.g., one data point for each processed claim, on the order of hundreds of thousands of data points per day. Agent 200 converts this claim processing information into uniform format and submits this information to data collector 300. Data collector 300 inserts this information into data store 400. Thus, data store 400 contains hundreds of thousands of data points that are created today, each data point representing an individual claim. Data store 400 stamps each of the data points with an expiration date set for 30 days from today's date. In 30 days from todays date, it is very unlikely that the processing information of each individual claim is going to be needed. In 30 days, compressor 600 will retrieve the hundreds of thousands of data points created today and will replace them with a set of monthly summaries, e.g., summarizing the number of claims and the amount of claims processed for each line of business during this month. In 90 days from today, compressor 600 will retrieve these monthly summaries and replace them with quarterly summaries. In 365 days from today, compressor 600 will retrieve these quarterly summaries and replace them with annual summaries. Thus, millions of original data points, with time, are replaced by a much smaller number of summarized data points, losing the detailed information of each individual claim, but preserving the summarized information (e.g., average turn-around-time).

Each of agents 200, 205 and 210, data collector 300, analyzer 500, compressor 600, presentation sub-system 700, user interface 800 and alert interface 900 may be implemented in software, and configured as a module of instructions or as a hierarchy of such modules, and stored in a memory for controlling a processor, e.g., a computer processor. Such instructions can also reside on a storage media 1000. Storage media 1000 can be any conventional storage media, including, but not limited to, a floppy disk, a compact disk, a magnetic tape, a read only memory, or an optical storage media. Storage media 1000 could also be a random access memory, or other type of electronic storage, located on a remote storage system and coupled to system 50.

In one embodiment, storage media 1000 includes (a) instructions for controlling a processor to convert a data point from a first format into a uniform format, where the data point represents data from an insurance claim, (b) instructions for controlling the processor to send the data point in the uniform format to a data store, where the data point is a member of a plurality of data points in the uniform format in the data store, and (c) instructions for controlling the processor to retrieve the plurality of data points from the data store and produce a metric from the plurality of data points.

In another embodiment, storage media 1000 includes (a) instructions for controlling a processor to convert a first data point from a first format into a uniform format, where the first data point represents data from an insurance claim, (b) instructions for controlling the processor to convert a second data point from a second format into the uniform format, where the second data point represents data from an insurance claim, and where the second format is different from the first format, (c) instructions for controlling the processor to send the first and second data points in the uniform format to a data store, where the first and second data points are members of a plurality of data points in the uniform format in the data store, and (d) instructions for controlling the processor to aggregate the plurality of data points from the data store, and produce a summary of the aggregated plurality of data points.

In yet another embodiment, storage media 1000 includes (a) instructions for controlling a processor to convert a first data point from a first format into a uniform format, where the first data point represents data from an insurance claim, (b) instructions for controlling the processor to convert a second data point from a second format into the uniform format, where the second data point represents data from an insurance claim, and where the second format is different from the first format, (c) instructions for controlling the processor to send the first and second data points to a data store, where the first and second data points are members of a plurality of data points in the uniform format in the data store, (d) instructions for controlling the processor to retrieve the plurality of data points from the data store and produce a metric from the plurality of data points, and (e) instructions for controlling the processor to issue an alert if the metric satisfies an alertable condition.

It should be understood that various alternatives, combinations and modifications of the teachings described herein could be devised by those skilled in the art. The present invention is intended to embrace all such alternatives, modifications and variances that fall within the scope of the appended claims.

1. An insurance claim processing system, comprising:
an agent that converts a data point from a first format into a uniform format, wherein said data point represents data from an insurance claim;
a collector that receives said data point in said uniform format and sends said data point to a data store, wherein said data point is a member of a plurality of data points in said uniform format in said data store; and
an analyzer that retrieves said plurality of data points from said data store and produces a metric from said plurality of data points.

2. The insurance claim processing system of claim 1, wherein said analyzer issues an alert if said metric satisfies an alertable condition.

3. The insurance claim processing system of claim 1, wherein said alertable condition is selected from the group consisting of (a) a threshold-based condition, (b) an experience-based condition, and (c) a rule-based condition.

4. The insurance claim processing system of claim 1, wherein said metric is in a form of a data cube.

5. The insurance claim processing system of claim 1,
wherein said agent is a first agent, and said data point is a first data point,
wherein the insurance claim processing system further comprises a second agent that converts a second data point from a second format into said uniform format, wherein said second data point represents data from an insurance claim, and wherein said second format is different from said first format, and
wherein said collector receives said second data point in said uniform format and sends said second data point to said data store.

6. The insurance claim processing system of claim 1,
wherein said metric is a first metric in a form of a first data cube having a first set of dimensions, and
wherein said analyzer produces a second metric from said plurality of data points in a form of a second data cube having a second set of dimensions.

7. The insurance claim processing system of claim 6, further comprising a presentation sub-system for sending said first metric and said second metric to a user interface.

8. The insurance claim processing system of claim 1, further comprising a compressor that aggregates said plurality of data points from said data store and produces a summary of said aggregated plurality of data points.

9. The insurance claim processing system of claim 8, wherein said plurality of data points, subsequent to being aggregated by said compressor, are deleted from said data store.

10. An insurance claim processing system, comprising:
a first agent that converts a first data point from a first format into a uniform format, wherein said first data point represents data from an insurance claim;
a second agent that converts a second data point from a second format into said uniform format, wherein said second data point also represents data from an insurance claim, and wherein said second format is different from said first format;
a collector that receives said first and second data points in said uniform format and sends said first and second data points to a data store, wherein said first and second data points are members of a plurality of data points in said uniform format in said data store; and
a compressor that aggregates said plurality of data points from said data store, and produces a summary of said aggregated plurality of data points.

11. The insurance claim processing system of claim 10, wherein said plurality of data points, subsequent to being aggregated by said compressor, are deleted from said data store.

12. An insurance claim processing system, comprising:
a first agent that converts a first data point from a first format into a uniform format, wherein said first data point represents data from an insurance claim;
a second agent that converts a second data point from a second format into said uniform format, wherein said second data point also represents data from an insurance claim, and wherein said second format is different from said first format;
a collector that receives said first and second data points in said uniform format and sends said first and second data points to a data store, wherein said first and second data points are members of a plurality of data points in said uniform format in said data store; and
an analyzer that retrieves said plurality of data points from said data store, produces a metric from said plurality of data points, and issues an alert if said metric satisfies an alertable condition.

13. The insurance claim processing system of claim 12, wherein said alertable condition is selected from the group consisting of (a) a threshold-based condition, (b) an experience-based condition, and (c) a rule-based condition.

14. A storage media, comprising:
instructions for controlling a processor to convert a data point from a first format into a uniform format, wherein said data point represents data from an insurance claim;
instructions for controlling said processor to send said data point in said uniform format to a data store, wherein said data point is a member of a plurality of data points in said uniform format in said data store; and
instructions for controlling said processor to retrieve said plurality of data points from said data store and produce a metric from said plurality of data points.

15. A storage media, comprising:
instructions for controlling a processor to convert a first data point from a first format into a uniform format, wherein said first data point represents data from an insurance claim;
instructions for controlling said processor to convert a second data point from a second format into said uniform format, wherein said second data point also represents data from an insurance claim, and wherein said second format is different from said first format;
instructions for controlling said processor to send said first and second data points in said uniform format to a data store, wherein said first and second data points are members of a plurality of data points in said uniform format in said data store; and
instructions for controlling said processor to aggregate said plurality of data points from said data store, and produce a summary of said aggregated plurality of data points.

16. A storage media, comprising:
instructions for controlling a processor to convert a first data point from a first format into a uniform format, wherein said first data point represents data from an insurance claim;
instructions for controlling said processor to convert a second data point from a second format into said uniform format, wherein said second data point also represents data from an insurance claim, and wherein said second format is different from said first format;
instructions for controlling said processor to send said first and second data points to a data store, wherein said first and second data points are members of a plurality of data points in said uniform format in said data store;
instructions for controlling said processor to retrieve said plurality of data points from said data store and produce a metric from said plurality of data points; and
instructions for controlling said processor to issue an alert if said metric satisfies an alertable condition.
